(19) United States
(12) Patent Application Publication
(10) Pub. No.: US 2004/0186233 A1
(43) Pub. Date: Sep. 23, 2004

(54) Molding composition containing (CO)polycarbonates

(76) Inventors: Melanie Moethrath, Dusseldorf (DE); Michael Erkelenz, Duisburg (DE); Klaus Horn, Dormagen (DE)

Correspondence Address: BAYER MATERIAL SCIENCE LLC, 100 BAYER ROAD, PITTSBURGH, PA, 15205, US

(21) Appl. No.: 10/792,494

(22) Filed: Mar. 3, 2004

(30) Foreign Application Priority Data
Mar. 10, 2003 (DE) 10310284.1

(51) Int. Cl. C08L 29/02

(52) U.S. Cl. 525/79; 525/92 R

(57) ABSTRACT

A thermoplastic molding composition comprising (A) 89 to 99 wt. % of a copolycarbonate and (B) 11 to 1 wt. % of a modifier is disclosed. The structure of the copolycarbonate contains 0.1 to 46 mol % of residues of compounds having formula (I),

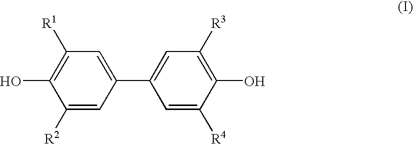

wherein R¹ to R⁴ independently one of the others denote H, C₁-C₄ alkyl, phenyl, substituted phenyl or halogen, and 99.9 to 54 mol % of residues of compounds having formula (II)

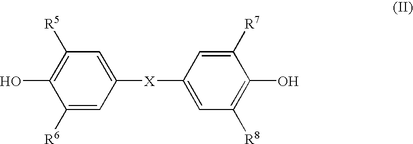

wherein R⁵ to R⁸ independently one of the others denote H, CH₃, Cl or Br and X is a member selected from the group consisting of C₁-C₅ alkylene, C₂-C₅ alkylidene, C₅-C₆ cycloalkylene and C₅-C₁₀ cycloalkylidene. The modifier (B) is at least one member selected from the group consisting of polybutylacrylate core-shell modifiers, olefin modifiers, poly(styrene-b-ethylene-cobutylene-b-styrene) modifiers, rubber graft polymers with at least one vinyl monomer graft polymer. The composition features good low-temperature properties and especially good ESC performance, and is suitable for applications in which especially good low-temperature properties and especially good ESC performance are required.

### FIELD OF THE INVENTION

The present invention is directed to thermoplastic molding compositions and in particular to compositions that contain a copolycarbonate.

### SUMMARY OF THE INVENTION

A thermoplastic molding composition comprising (A) 89 to 99 wt. % of a copolycarbonate and (B) 11 to 1 wt. % of a modifier is disclosed. The structure of the copolycarbonate contains 0.1 to 46 mol % of residues of compounds having formula (I),

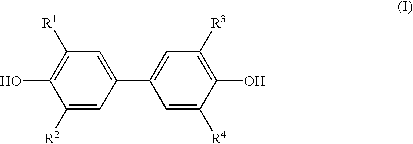

wherein R¹ to R⁴ independently one of the others denote H, C₁-C₄ alkyl, phenyl, substituted phenyl or halogen, and 99.9 to 54 mol % of residues of compounds having formula (II)

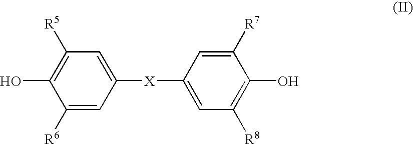

wherein R⁵ to R⁸ independently one of the others denote H, CH₃, Cl or Br and X is a member selected from the group consisting of C₁-C₅ alkylene, C₂-C₅ alkylidene, C₅-C₆ cycloalkylene and C₅-C₁₀ cycloalkylidene. The modifier (B) is at least one member selected from the group consisting of polybutylacrylate core-shell modifiers, olefin modifiers, poly(styrene-b-ethylene-cobutylene-b-styrene) modifiers, rubber graft polymers with at least one vinyl monomer graft polymer. The composition features good low-temperature properties and especially good ESC performance, and is suitable for applications in which especially good low-temperature properties and especially good ESC performance are required.

### BACKGROUND OF THE INVENTION

Polycarbonates that are as chemically resistant as possible and preferably transparent, which on the one hand are resistant to low temperatures and on the other display a high thermal stability, have long been sought for automotive construction and other exterior applications.

Copolycarbonates based on 4,4′-dihydroxydiphenyl and 2,2-bis(4-hydroxyphenyl) propane were already known from JP-A 5 117 382 and were described in EP-A 10 544 407, U.S. Pat. No. 5,470,938, U.S. Pat. No. 5,532,324 and U.S. Pat. No. 5,401,826 as being particularly resistant to chemicals, heat resistant and non-flammable with, in comparison to commercial polycarbonate made from bisphenol and having the same mechanical properties and transparency.

DE-A 10 047 483 describes copolycarbonates produced from 4,4′-dihydroxydiphenyl and 2,2-bis(4-hydroxyphenyl) propane (bisphenol A) that display especially good low-temperature properties.

DE-A 10 135 465 describes blends of copolycarbonates produced from 4,4′-dihydroxydiphenyl and 2,2-bis(4-hydroxyphenyl) propane (bisphenol A) and polycarbonate produced from pure 2,2-bis(4-hydroxyphenyl) propane with markedly improved low-temperature properties in comparison to bisphenol A polycarbonates.

DE-A 10 105 714 describes blends of copolycarbonates produced from 4,4′-dihydroxydiphenyl and 2,2-bis(4-hydroxyphenyl) propane (bisphenol A) with ABS graft polymers, which display an especially good ESC performance and low-temperature performance. However, their ABS content means that these blends have poorer thermal stability, heat resistance and poorer weathering characteristics (crosslinking of the ABS polymer under UV light irradiation) in comparison to the unblended copolycarbonate.

The object was therefore to improve the ESC performance of copolycarbonates produced from 4,4′-dihydroxydiphenyl and 2,2-bis(4-hydroxyphenyl) propane (bisphenol A) whilst retaining the especially good low-temperature properties and largely retaining the thermal stability, heat resistance and weathering characteristics known for copolycarbonates produced from 4,4′-dihydroxydiphenyl and 2,2-bis(4-hydroxyphenyl) propane (bisphenol A).

### DETAILED DESCRIPTION OF THE INVENTION

Surprisingly it has now been found that copolycarbonates containing specific dihydroxydiaryls such as 4,4′-dihydroxydiphenyl as comonomers in addition to bisphenol A, may be modified with small amounts, relative to the amount of end product, of polybutylacrylate core-shell modifiers or olefin modifiers or with poly(styrene-b-ethylene-cobutylene-b-styrene) modifiers or silicone-acrylic rubber modifiers in order to achieve improved ESC performance in comparison to pure polycarbonates produced from 4,4′-dihydroxydiphenyl and 2,2-bis(4-hydroxyphenyl) propane (bisphenol A), together with good low-temperature properties and together with good thermal stability and heat resistance.

This is particularly astonishing since in the production of modified polycarbonates it is generally impossible to predict which properties a modified polycarbonate will ultimately display. The properties of the starting polymer and the modifier may intensify, disappear, change (in either direction), in some circumstances the starting polymer and the modifier may no longer even be homogeneously miscible, etc. In short, no prediction may be made and a result such as that presented here is in no way obvious but on the contrary is extremely surprising.

The present invention therefore concerns compositions containing (A) 89 to 99 wt. % of copolycarbonate, which is synthesised from 0.1 mol % to 46 mol %, preferably 11 mol % to 34 mol % and in particular 26 mol % to 34 mol % of compounds having formula (I)

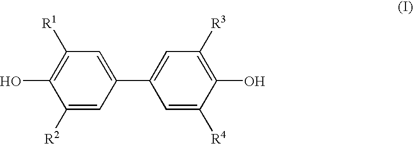

wherein R¹ to R⁴ mutually independently stand for H, C₁-C₄ alkyl, phenyl, substituted phenyl or halogen, preferably for H, C₁-C₄ alkyl or halogen and particularly preferably all stand for the same radical, in particular H or tert.-butyl, and complementary amounts, in other words 99.9% mol % to 54 mol %, preferably 89 mol % to 66 mol % and in particular 74 mol % to 66 mol % of compounds having formula (II)

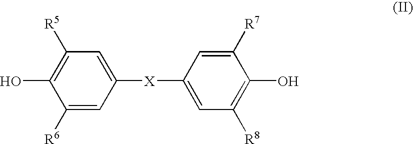

wherein R⁵ to R⁸ are mutually independently H, CH₃, Cl or Br and X is C₁-C₅ alkylene, C₂-C₅ alkylidene, C₅-C₆ cycloalkylene, C₅-C₁₀ cycloalkylidene, as bisphenol monomers, and (B) 11 to 1 wt. % of at least one modifier selected from the group consisting of polybutylacrylate core-shell modifier, olefin modifier, poly(styrene-b-ethylene-cobutylene-b-styrene) modifier, rubber graft polymers with at least one vinyl monomer graft polymer. Preferred mixtures of copolymer (A) with the respective modifier (B) are 91 to 99 wt. % (A), most particularly preferably 93 to 99 wt. % (A) with correspondingly complementary amounts of modifier (B).

The present invention also provides the use of the compositions according to the invention as materials in areas in which especially good ESC performance and low-temperature properties, heat resistance and thermal stability are required.

The modifiers (B) that are suitable for the polycarbonate compositions according to the invention are understood to be (B1) polybutylacrylate core-shell modifiers such as are described for example in U.S. Pat. No. 3,562,235 (column 1, line 28 to column 4, line 72), U.S. Pat. No. 3,808,180 (column 3, line 21 to column 10, line 55) or U.S. Pat. No. 3,859,389 (column 2, line 58 to column 5, line 15 and column 5, line 35 to column 6, line 54), all incorporated herein by reference (B2) olefin polymers from the group consisting of polyethylenes, polypropylenes and copolymers of propene and ethene, such as are all described in U.S. Pat. No. 3,431,224, column 2, line 48-72, and column 3, line 1-7, incorporated herein by reference (B3) poly(styrene-b-ethylene-cobutylene-b-styrene) modifiers having a tensile strength determined in accordance with ASTM-D412 of more than 20 MPa, less than 50 MPa, and a 300% modulus, ASTM-D412, of between 1 and 10 MPa, an elongation at break of 400 to 1500% (ASTM-D412), a hardness according to ASTM-D2240 of 30 to 100 Shore A, a density of 0.85 to 1.0 g/m³ and a styrene content of 12 to 35 wt. %, or (B4) rubber graft polymers which is the polymerization product of at least one vinyl monomer onto a rubber, wherein the rubber is composed of 10 to 90 wt. % of a polyorganosilane rubber and 10 to 90 wt. % of a polyalkyl(meth)acrylate rubber in a total quantity of 100 wt. % and has an average particle size of 0.08 to 0.6 μm in an inseparable interlocking fashion as described in U.S. Pat. No. 4,888,388 (column 3, line 68 to column 7, line 6), incorporated herein by reference or a mixture (B5) of a graft copolymer rubber compound with a vinyl monomer as described under (B4), as described in U.S. Pat. No. 4,888,388 (column 7, line 7 to column 7, line 65).

Preferred modifiers from these classes of compounds are Paraloid EXL 2300® and 3300® (Rohm & Haas), compounds from the Kraton G® range (Shell), Metablens from the S range® (Mitsubishi Rayon) and polypropylenes (Novolen Technology Holdings C.V.).

Particularly preferred modifiers from these classes of compounds are Paraloid EXL 2300® (methyl methacrylate-grafted butylacrylate rubber from Rohm & Haas), Kraton G 1651® (Shell), Metablen S2001® (a methyl methacrylate-grafted silicone-butylacrylate rubber from Mitsubishi Rayon) and Novolen 1100 L (Novolen Technology Holdings C.V.).

Kraton G 1651®, Metablen S2001® and Novolen 1100 L® are most particularly preferred.

Graft polymers with a core/shell structure are preferably used as graft polymers B. Suitable graft bases B.11 are for example acrylate and silicone-acrylate composite rubbers.

These graft bases generally have a mean particle size (d₅₀ value) of 0.01 to 5 μm, preferably 0.05 to 2 μm, in particular 0.1 to 1 μm.

The mean particle size d₅₀ is the diameter above and below which in each case 50% of the particles lie, and may be determined by means of ultracentrifuge measurements (W. Scholtan, H. Lange, Kolloid, Z. and Z. Polymere 250 (1972), 782-1796).

The gel content of these graft bases is at least 30 wt. %, preferably at least 40 wt. % (measured in toluene).

The gel content is determined at 25° C. in a suitable solvent (M. Hoffmann, H. Krömer, R. Kuhn, Polymeranalytik I and II, Georg Thieme-Verlag, Stuttgart 1977).

Particularly preferred as graft base B.11 are those acrylate rubbers or silicone-acrylate composite rubbers suitable for the graft polymers with a core/shell structure C, containing 0 to 100 wt. %, preferably 1 to 99 wt. %, in particular 10 to 99 wt. % and particularly preferably 30 to 99 wt. % of polyorganosiloxane component and 100 to 0 wt. %, preferably 99 to 1 wt. %, in particular 90 to 1 wt. % and particularly preferably 70 to 1 wt. % of polyalkyl (meth)acrylate rubber component (the total amount of the respective rubber components totals 100 wt. %).

Preferred silicone-acrylate rubbers that may be used are those whose production is described in JP 08 259 791-A, JP 07 316 409-A, EP-A 0 315 035 and U.S. Pat. No. 4,963,619 the indicated equivalent of EP 315035 are incorporated herein by reference.

The polyorganosiloxane component in the silicone-acrylate composite rubber may be produced by reacting an organosiloxane and a multifunctional crosslinking agent in an emulsion polymerization process. It is also possible to incorporate graft-active sites into the rubber by adding suitable unsaturated organosiloxanes.

The organosiloxane is generally cyclic, the ring structures preferably containing 3 to 6 Si atoms. There may for example be mentioned hexamethylcyclotrisiloxane, octamethylcyclotetrasiloxane, decamethylcyclopentasiloxane, dodecamethylcyclohexa-siloxane, trimethyltriphenylcyclotrisiloxane, tetramethyltetraphenylcyclotetrasiloxane and octaphenylcyclotetrasiloxane, which may be used individually or as a mixture of two or more compounds. The organosiloxane component is included in the structure of the silicone fraction in the silicone-acrylate rubber in an amount of at least 50 wt. %, preferably at least 70 wt. %, referred to the silicone fraction in the silicone-acrylate rubber.

3- or 4-functional silane compounds are generally used as crosslinking agents. The following particularly preferred compounds may be mentioned by way of example: trimethoxymethylsilane, triethoxyphenylsilane, tetramethoxysilane, tetraethoxysilane, tetra-n-propoxysilane, tetrabutoxysilane and 4-functional branching agents, in particular tetraethoxysilane. The amount of branching agent is generally 0 to 30 wt. % (referred to the polyorganosiloxane component in the silicone-acrylate rubber).

Compounds that form one of the following structures are preferably used to incorporate graft-active sites in the polyorganosiloxane component of the silicone-acrylate rubber:

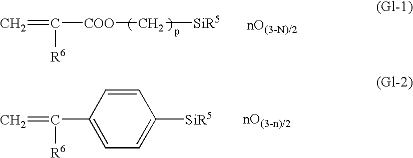

CH₂═CH—SiR⁵nO_{(3-n)/2} (GI-3)

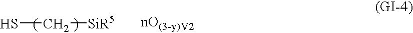

wherein

R⁵ denotes methyl, ethyl, propyl or phenyl,

R⁶ denotes hydrogen or methyl,

n is 0, 1 or 2, and

p is 1 to 6.

(Meth)acryloyloxysilane is a preferred compound for the formation of the structure (GI-1). Preferred (meth)acryloyloxysilanes include for example β-methacryloyl-oxyethyl-dimethoxy-methylsilane, γ-methacryloyl-oxy-propylmethoxy-dimethylsilane, γ-methacryloyloxypropyl-dimethoxy-methylsilane, γ-methacryloyloxypropyl-trimethoxy-silane, γ-methacryloyloxy-propyl-ethoxy-diethyl-silane, γ-methacryloyloxypropyl-diethoxy-methylsilane, γ-methacryloyloxy-butyl-diethoxy-methylsilane.

Vinylsiloxanes, in particular tetramethyl-tetravinyl-cyclotetrasiloxane, are suitable for forming the structure GI-2.

For example, p-vinylphenyl-dimethoxy-methylsilane may form the structure GI-3. γ-mercaptopropyldimethoxy-methylsilane, γ-mercaptopropylmethoxy-dimethylsilane, γ-mercaptopropyldiethoxymethylsilane may form the structure GI-4.

The amount of these compounds is 0 to 10 wt. %, preferably 0.5 to 5 wt % (referred to the polyorganosiloxane component).

The acrylate component (graft base) may be produced from alkyl (meth)acrylates, crosslinking agents and graft-active monomer (the latter especially in the case of a silicone-acrylate composite rubber).

As alkyl (meth)acrylates the following may be mentioned by way of example and are preferred: alkyl acrylates such as methyl acrylate, ethyl acrylate, n-propyl acrylate, n-butyl acrylate, 2-ethylhexyl acrylate and alkyl methacrylates such as hexyl methacrylate, 2-ethylhexyl methacrylate and n-lauryl methacrylate; n-butyl acrylate is particularly preferred.

Multifunctional compounds may be used as crosslinking agents. The following may be mentioned by way of example: ethylene glycol dimethacrylate, propylene glycol dimethacrylate, 1,3-butylene glycol dimethacrylate and 1,4-butylene glycol dimethacrylate.

The following compounds may be used for example, individually or as a mixture, for forming graft-active sites: allyl methacrylate, triallyl cyanurate, triallyl isocyanurate and allyl methacrylate. Allyl methacrylate may also act as crosslinking agent. These compounds are used in amounts of 0.1 to 20 wt. % referred to the acrylate rubber component in the silicone-acrylate composite rubber.

Methods for the production of the silicone-acrylate composite rubbers preferably used in the compositions according to the invention as well as their grafting with monomers are described for example in U.S. Pat. No. 4,888,388, JP 08 259 791 A2, JP 07 316 409A and EP-A 0 315 035. As graft base C.1 for the graft polymer C there may be used those silicone-acrylate composite rubbers whose silicone and acrylate components form a core/shell structure, as well as those that form a network in which the acrylate and silicone components completely interpenetrate one another (interpenetrating network).

The graft polymerization on the aforedescribed graft bases may be carried out in suspension, dispersion or emulsion. Continuous or batchwise emulsion polymerization is preferred. This graft polymerization is carried out using free-radical initiators (e.g. peroxides, azo compounds, hydroperoxides, persulfates, perphosphates) and optionally with the use of anionic emulsifiers, for example carboxonium salts, sulfonic acid salts or organic sulfates. In this way graft polymers are formed with high graft yields, i.e. a large proportion of the polymer of the graft monomers is chemically bonded to the rubber.

The graft shell C.2 is formed from (meth)acrylic acid (C₁-C₈) alkyl esters, preferably methyl methacrylate, n-butyl acrylate and/or tert.-butyl acrylate.

Particularly preferred are methyl methacrylate-grafted butyl acrylate rubber and methyl methyacrylate-grafted silicone-butylacrylate composite rubber.

A mixture of two or more of the modifiers (B) previously described as suitable compounds may also be used as the modifier (B).

Most particularly preferred are mixtures of modifiers (B) with copolycarbonates (A), wherein the copolycar-bonates (A) are synthesised from 34-26 mol %, especially 33-27 mol %, in particular 32-28 mol %, most especially 31-29 mol % and most particularly of all 30 mol % of bisphenol monomer having formula (I), supplemented in each case by a complementary content of bisphenol monomer having formula (II).

The stated percentages of bisphenol monomers relate to the total content of bisphenols in the polycarbonates defined as 100%. A pure bisphenol A polycarbonate would then consist of 100% bisphenol A. The carbonate content derived from carbonic acid esters or halides is not taken into consideration here.

Compositions displaying the compositions cited as being preferred, particularly preferred or most particularly preferred are preferred, particularly preferred or most particularly preferred.

The definitions, proportions and explanations cited in the description in general terms or in preferential ranges may also however be combined with one another in any way, in other words across the individual ranges and preferential ranges. They apply accordingly to the end products and to the preliminary products and intermediate products.

It has now surprisingly been found that the polycarbonate compositions according to the invention display an improved ESC performance in comparison to copolycarbonates produced from 4,4′-dihydroxydiphenyl and 2,2-bis(4-hydroxyphenyl) propane (bisphenol A), together with good low-temperature properties and good thermal stability and heat resistance.

The modified copolycarbonates may therefore be used as moulded parts wherever the general properties of the polycarbonates known until now are inadequate, in particular for example in the electrical sector, in the protective clothing sector, in particular for safety helmets and visors, and in the construction sector, for covers or glazing systems, in particular in the motor vehicle sector as films, sheets, fittings or housing components, but also in the optical sector as lenses and data storage media and as consumer articles, namely where increased heat or chemical resistance combined with good low-temperature properties are required. They can moreover also replace other materials in applications in which conventional polycarbonates could previously not be used because of their inadequate low-temperature properties.

According to the invention the term good low-temperature properties is understood to mean by way of example, but not restrictively, good low-temperature impact strength, since conventional polycarbonates become brittle at low temperatures and therefore tend to fracture and crack.

According to the invention low temperatures are temperatures below 0° C., particularly preferably below −10° C., most particularly preferably below −20° C., especially preferably below −30° C. and above all below −40° C.

According to the invention good ESC performance is understood to mean by way of example, but not restrictively, good chemical resistance under load according to DIN 53449/3 (bent strip test) after being stored for one hour at 22° C. in i-octane/toluene 1/1.

According to the invention good thermal stability is understood to mean by way of example, but not restrictively, the stability in terms of colour and impact strength of the compositions according to the invention at material processing temperatures of over 290° C., preferably over 300° C.

According to the invention good heat resistance is understood to mean by way of example, but not restrictively, a dimensional stability of the materials above 140° C., preferably above 150° C.

Preferred compounds having formula (I) are 4,4′-dihydroxydiphenyl (DOD) and 4,4′-dihydroxy-3,3′,5,5′-tetra(tert.-butyl)diphenyl, 4,4′-dihydroxy-3,3′,5,5′-tetra(n-butyl)diphenyl and 4,4′-dihydroxy-3,3′,5,5′-tetra(methyl)diphenyl, 4,4′-dihydroxydiphenyl being particularly preferred.

Preferred compounds having formula (II) are 2,2-bis(4-hydroxyphenyl) propane, 1,1-bis(4-hydroxyphenyl)-3,3,5-trimethyl cyclohexane and 1,3-bis[2-(4-hydroxyphenyl)-2-propyl]benzene, 1,1-bis(4-hydroxyphenyl)-1-phenylethane, 1,1-bis(4-hydroxyphenyl) cyclohexane, in particular 2,2-bis(4-hydroxyphenyl) propane (bisphenol A) and 1,1-bis(4-hydroxyphenyl)-3,3,5-trimethyl cyclohexane (bisphenol TMC), most particularly preferably 2,2-bis(4-hydroxyphenyl) propane (bisphenol A).

The copolycarbonate (A) may contain both one compound having formula (I) and several compounds having formula (I).

In the same way (A) may contain both one compound having formula (II) and several compounds having formula (II).

The production of (co)polycarbonates is generally known in the literature.

On the production of polycarbonates by the interfacial polycondensation process or the melt interesterification process, reference is made by way of example to “Schnell”, Chemistry and Physics of Polycarbonates, Polymer Reviews, Vol. 9, Interscience Publishers, New York, London, Sydney 1964 p. 33 ff. and to Polymer Reviews, Volume 10, “Condensation Polymers by Interfacial and Solution Methods”, Paul W. Morgan, Interscience Publishers, New York 1965, chapter VIII, p. 325 and EP-A 971790.

According to DE-A 2 119 779 the production of copolycarbonates incorporating monomers having formula (I) is preferably performed in solution, namely by the interfacial polycondensation process and the process in homogeneous phase. In addition, they may also be produced by the known polycarbonate production process in the melt (the so-called melt interesterification process), as described for example in DE-A 1 96 46 401 or in DE-A 42 38 123. Interesterification processes (acetate process and phenyl ester process) are also described for example in U.S. Pat. Nos. 3,494,885, 4,386,186, 4,661,580, 4,680,371 and 4,680,372, in EP-A 26 120, 26 121, 26 684, 28 030, 39 845, 39 845, 91 602, 97 970, 79 075, 146 887, 156 103, 234 913 and 240 301, and in DE-A 1 495 626 and 2 232 977.

The modifiers (B) according to the invention preferably come from commercial sources and may be produced according to the aforementioned relevant patent specifications.

The polymer (A) and the modifier (B) could contain impurities as a consequence of the synthesis process. A high purity is desirable and to be sought, however, so they are used with the highest possible purity for production of the modified copolycarbonates.

The modified copolycarbonates according to the invention may contain various terminal groups. These are introduced by means of chain terminators. Chain terminators within the meaning of the invention are those having formula (III)

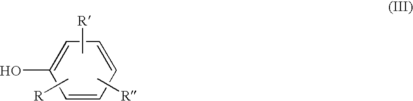

wherein R, R′ and R″ mutually independently denote H, optionally branched C₁-C₃₄ alkyl/cycloalkyl, C₇-C₃₄ alkaryl or C₆-C₃₄ aryl, for example butyl phenol, trityl phenol, cumyl phenol, phenol, octyl phenol, preferably butyl phenol or phenol.

The copolycarbonate (A) may contain small amounts from 0.02 to 3.6 mol % (relative to the dihydroxy compound) of branching agents. Suitable branching agents are the compounds that are suitable for polycarbonate production having three or more functional groups, preferably those having three or more than three phenolic OH groups, for example 1,1,1-tri-(4-hydroxyphenyl) ethane and isatin bis-cresol.

Auxiliary substances and reinforcing materials may be added to the compositions according to the invention to modify their properties. Suitable examples include inter alia: heat and UV stabilisers, flow control agents, mold release agents, flame retardants, pigments, finely dispersed minerals, fiberous materials, e.g. alkyl and aryl phosphites, phosphates, phosphanes, low molecular weight carboxylic acid esters, halo compounds, salts, chalks, silica flour, glass and carbon fibers, pigments and combinations thereof. Such compounds are described for example in WO 99/55772, p. 15-25, and in “Plastics Additives”, R. Gächter and H. Müller, Hanser Publishers 1983.

In addition, other polymers may also be added to the modified copolycar-bonates according to the invention, e.g. other polycarbonates, polyolefins, polyurethanes, polyesters and polystyrenes.

Bisphenol A polycarbonate may preferably be added to the modified copolycarbonates according to the invention. Makrolon 3108 may particularly preferably be added to the modified copolycarbonates according to the invention.

Up to 10 wt. % Makrolon 3108 relative to the modified copolycarbonates according to the invention are preferably used, particularly preferably up to 5 wt. %.

Makrolon 3108 is an unbranched homopolycarbonate based on bisphenol A with a weight average molecular weight (M_{w}) of 31000 g mol⁻¹.

These substances may preferably be added to the finished polycarbonate in conventional equipment but may also be added at another stage of the production process, depending on requirements.

The copolycarbonate (A) that is used displays molecular weights of between M_{w} (weight-average molecular weight) 10,000 to 60,000, preferably M_{w} 20,000 to 55,000, determined by measuring the relative solution viscosity in dichloromethane or in mixtures of equal amounts by weight of phenol/o-dichlorobenzene, calibrated by light scattering. It may already contain additives or stabilisers such as may also be added to the blends according to the invention.

The present application also provides the modified copolycarbonates according to the invention themselves.

The modified copolycarbonates according to the invention are melt processable by conventional means at temperatures of 240° C. to 380° C., preferably 260° C. to 360° C. All sorts of molded parts and films may be produced by known means by injection molding or via extrusion. The present invention also provides molded parts and extrudates produced from the modified copolycarbonates according to the invention.

The modified copolycarbonates according to the invention are readily soluble in solvents such as chlorinated hydrocarbons, e.g. methylene chloride, and may therefore be processed by known means into cast films.

The combination of properties such as heat resistance, thermal stability, good low-temperature properties and chemical resistance means that the modified copolycarbonates according to the invention are suitable for a broad range of uses. Possible applications of the blends according to the invention that may be cited here by way of example, without however imposing any restrictions, are

1. Safety glass, which is known to be needed in many areas of buildings, vehicles and aircraft, and as visors for helmets,

2. Production of films, particularly films for skis,

3. Production of blow mouldings (see for example U.S. Pat. No. 2,964,794), for example 1 to 5 gallon water bottles,

4. Production of translucent sheets, in particular twin-wall sheets, for example for covering buildings such as stations, greenhouses and lighting installations,

5. Production of optical data storage media,

6. For producing traffic light housings or road signs,

7. For producing foams (see for example DE-B 1 031 507),

8. For producing threads and wires (see for example DE-B 1 137 167 and DE-A 1 785 137),

9. As translucent plastics containing glass fibres for lighting applications (see for example DE-A 1 554 020),

10. As translucent plastics containing barium sulfate, titanium dioxide and/or zirconium oxide or organic polymeric acrylate rubbers (EP-A 634 445, EP-A 269324) for producing translucent and light-scattering moulded parts,

11. For producing precision injection mouldings, such as e.g. lens holders, polycarbonates having a content of glass fibres and optionally additionally containing around 1-10 wt. % MoS₂, relative to the total weight, being used for this purpose,

12. For producing optical device components, in particular lenses for photographic and film cameras (see for example DE-A 2 701 173),

13. As light carriers, in particular as optical cables (see for example EP-A1 0 089 801),

14. As electrical insulating materials for electrical cables and for connector shells and plug-in connectors,

15. Manufacture of mobile telephone casings with improved resistance to perfume, aftershave and perspiration,

16. Network interface devices,

17. As supports for organic photoconductors,

18. For manufacturing lamps, e.g. headlamps, diffusers or internal lenses,

19. For medical applications, e.g. oxygenators, dialysis machines,

20. For food applications, such as e.g. bottles, crockery and chocolate moulds,

21. For applications in the automotive sector, where contact may occur with fuels and lubricants, such as e.g. bumpers, optionally in the form of suitable blends with ABS or suitable rubbers,

22. For sports articles, such as e.g. slalom poles or ski boot clips,

23. For domestic items such as e.g. kitchen sinks and letterboxes,

24. For housings, such as e.g. electrical distribution cabinets,

25. Casings for electric toothbrushes and hairdryer casings,

26. Transparent washing machine portholes with improved resistance to detergent solution,

27. Protective goggles, optical correction spectacles,

28. Lamp covers for kitchen appliances with improved resistance to kitchen vapours, particularly oil vapours,

29. Packaging films for drug products,

30. Chip boxes and chip carriers,

31. Protective clothing such as safety helmets and visors,

32. For other applications, such as e.g. stable doors or animal cages.

The compositions according to the invention are particularly suitable mutually independently for use in protective clothing, in optical applications, in medical and food applications, in films, in the automotive sector, in exterior applications and in the electrical sector.

In particular, films may be produced from the high molecular weight, aromatic, modified copolycarbonates according to the invention. The films have preferred thicknesses of between 1 and 1500 μm, in particular preferred thicknesses of between 10 and 900 μm.

The films obtained may be monoaxially or biaxially stretched by known means, preferably in the ratio 1:1.5 to 1:5.

The films may be produced by the known processes for film production, e.g. by extrusion of a polymer melt through a slot die, by blowing on a film-blowing machine, by thermoforming or casting. It is possible for these films to be used by themselves. They may of course also be used to produce composite films with other plastic films by the conventional processes, all known films being suitable in principle as partners, depending on the desired application and final property of the composite film. A composite may be produced from two or more films. In addition, the modified copolycarbonates according to the invention may also be used in other laminate systems, such as e.g. in coextruded sheets.

The examples below are intended to illustrate the present invention without however restricting it:

### EXAMPLES

The polycarbonates used were synthesised by the known production processes in the melt, as described for example in DE-A 42 38 123, and by means of the interfacial polycondensation process, as described for example in “Schnell”, Chemistry and Physics of Polycarbonates, Polymer Reviews, Vol. 9, Interscience Publishers, New York, London, Sydney 1964, p. 33 ff.

In example 1 a polycarbonate was produced with 30 mol % dihydroxydiphenyl (DOD) and 70 mol % bisphenol A as copolycarbonate (A). Tert.-butyl phenol was used as the chain terminator. The pellets display a relative solution viscosity of 1.30 and an average molecular weight M_{w} of 20,000 g mol⁻¹.

The commercially available compounds Paraloid® EXL 2300, Kraton® G 1651, Metablen® S2001 and Novolen® 1100 L were used as modifiers (B).

In example 2 to 7 a bisphenol A polycarbonate having a molecular weight of 31,000 g mol⁻¹, expressed as a relative solution viscosity (eta rel) of 1.31, was additionally used.

In comparative example 1 a copolycarbonate was produced with 30 mol % dihydroxydiphenyl (DOD) and 70 mol % bisphenol A. The pellets display a relative solution viscosity of 1.30.

In comparative example 2 a bisphenol A polycarbonate having a molecular weight of 31,000 g mol⁻¹, expressed as a relative solution viscosity (eta rel) of 1.31, was used.

In comparative example 3 (DE-A 101 05 714) 70 mol % of a copolycarbonate, with 30 mol % dihydroxydiphenyl (DOD) and 70 mol % bisphenol A having a M_{w} of 25620 g mol⁻¹, with 13 mol % of a graft polymer, of 40 wt. % of a copolymer of styrene and acrylonitrile in the ratio 73:27 on 60 wt. % of crosslinked polybutadiene rubber (d₅₀=0.28 μm) in particle form, was produced by emulsion polymerisation and blended with 17 mol % styrene/acrylonitrile copolymer with a styrene/acrylonitrile ratio of 72:28 and an intrinsic viscosity of 0.55 dl/g measured in dimethyl formamide at 20° C.

The relative solution viscosity was determined in dichloromethane at a concentration of 5 g/l at 25° C.

The flexural impact test according to ISO 180/4A was used to determine the impact strength. Ten specimens were measured in each case. The value displayed by the majority of the specimens is given in Table 1.

The chemical resistance under load according to DIN 53449/3 (bent strip test) in isooctane/toluene 1/1 is performed to determine the ESC performance.

The thermal stability of the samples is measured at 290 and 300° C. Test pieces are produced by injection moulding at various temperatures and then assessed visually.

Compounding to a blend was performed on a ZSK 32 (twin screw extruder, Werner & Pfleiderer, Stuttgart) at 300° C. and with a throughput of 10 kg/h.

The composition is shown in Table 1, values are given in wt. % of the composition.

TABLE 1
(values stated in wt. % of the composition)

| | Example | | | | | | Comp. | Comp. |
|---|---|---|---|---|---|---|---|---|
| | 1 | 2 | 3 | 4 | 5 | 6 | 1 | 2 |
| Component | 95 | 92 | 87 | 95 | 92 | 95 | 100 | — |
| A | | | | | | | | |
| BPA-PC | — | 3 | 3 | 3 | 3 | — | — | 100 |
| Paraloid | 5 | — | — | — | — | — | — | — |
| EXL 2300 | | | | | | | | |
| Kraton | — | 5 | 10 | — | — | — | — | — |
| G1651 | | | | | | | | |
| Novolen | — | — | — | 2 | 5 | — | — | — |
| 1100L | | | | | | | | |
| Metablen | — | — | — | — | — | 5 | — | — |
| S2001 | | | | | | | | |

TABLE 2
The results of the low-temperature impact strength and chemical resistance under load

| | Bent strip | Bent strip | Bent strip | Notched impact resistance to ISO 180/4A [kJ/m²] | | | | | |
|---|---|---|---|---|---|---|---|---|---|
| Example | test 0% | test 0.6% | test 1.0% | 0° C. | −20° C. | −30° C. | −40° C. | −50° C. | −60° C. |
| Example 1 | nf | 5 nf | 46b | — | 47d | 44d | 8x37d, 2x25b | — | — |
| Example 2 | nf | 3 × nf, 90d | 74d | — | 41d | — | 41d | 10x20b | — |
| Example 3 | nf | nf | 81d | — | 36d | — | 34d | 10x19b | — |
| Example 4 | nf | 3 × nf, 73d | 54*b | — | 54d | — | 54d | 52d | 5x43d, 5x30b |
| Example 5 | nf | 4x84 | 54 d | — | 43d | — | 37d | 7x34d, 3x29b | — |
| Example 6 | nf | 2 × nf, 65d | 35*b | — | 43d | — | 38d | 36d | 5x35d, 5x28b |
| Comp. ex. 1 | nf | 8b | 7 b | — | 54d | — | — | 51d | 47d |
| Comp. ex. 2 | nf | 8b | 8 b | 95d | d/b | 15b | — | — | — |

nf: not fractured,
d: ductile,
b: brittle fracture
*edge cracking
**transverse cracking
“5 nf” means 5 probes are tested, results:
nf = not fractured
“3 × nf, 90 d” means 4 probes are tested, 3 probes having a result of “nf”, 1 probe having a notched impact resistance of 90 kJ/m², d = ductile

It is clear from Table 2 that the modified polycarbonates surprisingly display a clearly improved chemical resistance in comparison to the unmodified polycarbonates included in the comparative examples. This means that in the bent strip test under outer fiber strain they do not fracture or fracture only under exposure to significantly greater stress than in the case of the unmodified polycarbonates. Surprisingly, most of the modified samples (examples 2, 3, 5) display ductile behaviour even at 1.0% outer fibre strain. In contrast, the comparative examples display undesirable brittle fracture behavior under outer fiber strain under the smallest load. Equally striking is that in spite of their good chemical resistance, the ductile/brittle transition in the notched impact resistance of the modified samples occurs at temperatures of −40 and −50° C. and even, in the case of example specimens 4 and 6, as low as −60° C. Although comparative example 1 displays a ductile/brittle transition below −60° C., its chemical resistance is dramatically inferior.

TABLE 3
Thermostability results

| | Example | | | | | | |
|---|---|---|---|---|---|---|---|
| | 1 | 2 | 3 | 4 | 5 | 6 | Comp. Example 3 |
| 290° C.¹⁾ | 1 | 1 | 1 | 1 | 1 | 1 | 3 |
| 300° C.¹⁾ | 1 | 1 | 1 | 1 | 1 | 1 | 2 |

¹⁾molding temperature
Thermostability is assessed visually (with rating of 1, 2 or 3).

Thermostability is assessed visually (with a rating of 1, 2 or 3).

The larger the number, the grater the damage of the sample, which thus displays corresponding surface defects. The number 1 signifies no surface defects or streak formation and the number 2 signifies small surface defects or low streak formation. The number 3 signifies major surface defects or streak formation. It can be seen that all of the moulding compositions according to the invention have superior thermostability to comparative example 3.

The examples thus clearly verify the surprising superiority of the modified polycarbonates according to the invention, which display a markedly superior chemical resistance combined with good low-temperature properties and heat resistance.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic molding composition comprising (A) 89 to 99 wt. % of a copolycarbonate and (B) 11 to 1 wt. % of a modifier, wherein the structure of the copolycarbonate contains 0.1 to 46 mol % of residues of compounds having formula (I), 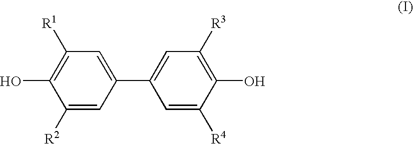
wherein R¹ to R⁴ independently one of the others denote H, C₁-C₄ alkyl, phenyl, substituted phenyl or halogen, and 99.9 to 54 mol % of residues of compounds having formula (II) 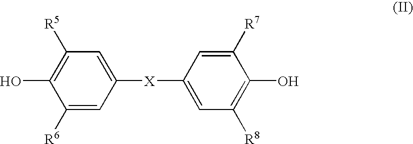
wherein R⁵ to R⁸ independently one of the others denote H, CH₃, Cl or Br and X is a member selected from the group consisting of C₁-C₅ alkylene, C₂-C₅ alkylidene, C₅-C₆ cycloalkylene and C₅-C₁₀ cycloalkylidene and wherein (B) is at least one member selected from the group consisting of polybutylacrylate core-shell modifiers, olefin modifiers, poly(styrene-b-ethylene-cobutylene-b-styrene) modifiers, rubber graft polymers with at least one vinyl monomer graft polymer, the wt % being relative to the weight of the composition.

2. The composition according to claim 1 wherein the copolycarbonate contains 34 to 26 mol % of residues of compounds having formula (I) and a complementary amount of residues of compounds having formula (II).

3. The composition according to claim 1 wherein the compound having formula (I) is dihydroxydiphenol and the compound having formula (II) is bisphenol A.

4. The composition according to claim 1 wherein (A) is present in an amount of (A) is 91 to 99 wt. % and (B) is present in an amount of 9 to 1 wt. %.

5. The composition according to claim 1 further containing a homopolycarbonate based on bisphenol A in a positive amount up 10% relative to the weight of the composition.

6. The composition according to claim 5 wherein homopolycarbonate has a weight average molecular weight of 31,000 g mol⁻¹ and an relative viscosity of 1.31

7. The composition according to claim 1 wherein the modifier B) is selected from the group consisting of a butylacrylate rubber grafted with methylmethacrylate and a silicone-butylacrylate-composite rubber grafted with methylmethacrylate.

8. A molded article comprising the composition of claim 1
